(19) United States
(12) Patent Application Publication
(10) Pub. No.: US 2003/0078799 A1
(43) Pub. Date: Apr. 24, 2003

(54) Mask trading system and method

(76) Inventors: Masafumi Asano, Yokohama-shi (JP); Katsuya Okumura, Tokyo (JP); Toshiya Kotani, Sagamihara-shi (JP); Takahiro Ikeda, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/235,915

(22) Filed: Sep. 6, 2002

(30) Foreign Application Priority Data
Sep. 21, 2001 (JP) 2001-289743

(51) Int. Cl. G06F 17/60; G06F 19/00

(52) U.S. Cl. 705/1; 700/95

(57) ABSTRACT

A mask trading system includes a purchase mediating section configured to exchange information with a buyer through a network, and a sales mediating section configured to exchange information with a seller. A manufacture order storing section is configured to store a mask manufacture order, which includes design specifications of a mask, and is inputted through the purchase mediating section. The mask trading system further includes an image storing section configured to store a shape image, which includes a two-dimensional shape of a pattern corner portion in a mask product, and is inputted through the sales mediating section. An image providing section is configured to transmit the shape image to the buyer through the purchase mediating section.

### CROSS-REFERENCE TO RELATED APPLICATIONS

This application is based upon and claims the benefit of priority from the prior Japanese Patent Application No. 2001-289743, Sep. 21, 2001, the entire contents of which are incorporated herein by reference.

### BACKGROUND OF THE INVENTION

1. Field of the Invention

The present invention relates to a mask trading system and method for trading, through a network, a photo mask used for manufacturing semiconductor devices.

2. Description of the Related Art

In general, trading of a photo mask used for manufacturing semiconductor devices proceeds basically as follows: First, a mask buyer gives a written order to a mask manufacturer. The written order contains various information, such as design specifications, quantity, desired delivery date, and examination specifications of the mask. The mask manufacturer manufactures the ordered mask in a factory in accordance with the written order. Then, the mask manufacturer examines the manufactured mask product. If the examination data of the product does not conform to the specifications in the written order, the mask manufacturer re-manufactures a mask product. In such a manner, the mask manufacturer repeats the manufacture and examination of the mask until a manufactured mask product conforms to the specifications in the written order. Then, the final mask product is delivered to the buyer.

In recent years, with the increase in the degree of integration and fineness of semiconductor circuits, some problems have arisen in the mask trading manner described above. First, since design specifications required by mask buyers are becoming stricter, the yield in mask manufacturing is lowering while the cost thereof is rising. In addition, the increase in the degree of fineness of semiconductor circuits has brought about a change in exposure processes with an increase in the optical proximity effect (OPE). Accordingly, it is difficult with conventional finishing examinations in mask factories to judge whether a mask product satisfies requirements set out by the mask buyer.

Specifically, for example, although the two-dimensional shape of a corner portion in a pattern formed on a mask is greatly influential in forming a pattern on a wafer, the degree of the influence depends on the exposure apparatus and the photo-resist material used in the exposure process. Accordingly, it is very difficult for a mask factory side to judge as to how much finishing of a mask product is allowable on the mask buyer side.

Furthermore, even where various items in the design specifications of a mask (dimensions, defects, transmittance, phase angle difference, etc.) are not entirely satisfied, a mask buyer may use a mask product with some specific limitations. For example, even where a mask product includes defects thereon, the mask product can be satisfactory used by the mask buyer in the case of confirming a pattern shape to be formed on wafers. In this case, it may be advisable, in terms of total cost, to use an imperfect mask product for a wafer process, rather than to wait for a perfect mask product to be completed.

### BRIEF SUMMARY OF THE INVENTION

According to a first aspect of the present invention, there is provided a mask trading system for trading a photo mask used for manufacturing semiconductor devices, the system comprising:

a purchase mediating section configured to exchange information with a mask buyer through a network;

a sales mediating section configured to exchange information with a mask seller;

a manufacture order storing section configured to store a mask manufacture order, which includes design specifications of a mask, and is inputted through the purchase mediating section;

an image storing section configured to store a shape image, which includes a two-dimensional shape of a pattern corner portion in a mask product manufactured in a mask factory in accordance with the design specifications of the mask, and is inputted through the sales mediating section;

an image providing section configured to transmit the shape image to the mask buyer through the purchase mediating section.

According to a second aspect of the present invention, there is provided a mask trading method of trading a photo mask used for manufacturing semiconductor devices, using a system including a purchase mediating section configured to exchange information with a mask buyer through a network, and a sales mediating section configured to exchange information with a mask seller, the method comprising:

storing a mask manufacture order, which includes design specifications of a mask, and is inputted through the purchase mediating section;

storing a shape image, which includes a two-dimensional shape of a pattern corner portion in a mask product manufactured in a mask factory in accordance with the design specifications of the mask, and is inputted through the sales mediating section; and

transmitting the shape image to the mask buyer through the purchase mediating section.

According to a third aspect of the present invention, there is provided a mask trading method of trading a photo mask used for manufacturing semiconductor devices, using a system including a purchase mediating section configured to exchange information with a mask buyer through a network, and a sales mediating section configured to exchange information with a mask seller, the method comprising:

storing in the system a mask manufacture order, which includes design specifications of a mask, and is inputted through the purchase mediating section;

transmitting the mask manufacture order from the system to a mask factory through the sales mediating section;

manufacturing a mask product in the mask factory in accordance with the design specifications of the mask;

forming a shape image, which includes a two-dimensional shape of a pattern corner portion in the mask product;

inputting the shape image into the system through the sales mediating section and storing the shape image in the system;

transmitting the shape image from the system to the mask buyer through the purchase mediating section; and

allowing the mask buyer through the purchase mediating section to select whether to purchase the mask product, or to re-manufacture a mask product in accordance with the design specifications of the mask, after the shape image is transmitted to the mask buyer.

### BRIEF DESCRIPTION OF THE SEVERAL VIEWS OF THE DRAWING

FIG. 1 is a block diagram showing how terminal units on a mask buyer side and a mask factory are related to a system for trading a photo mask used for manufacturing semiconductor devices, according to an embodiment of the present invention;

FIG. 2 is a flowchart showing a business flow of a mask trading method performed by the system shown in FIG. 1;

FIG. 3 is a view showing a screen picture displayed for a mask buyer to input a mask manufacture order;

FIG. 4 is a view showing a screen picture displayed for the mask buyer to select whether to proceed with manufacture of the mask or not;

FIG. 5 is a view showing a screen picture displayed for the mask buyer to see examination data and a shape image;

FIG. 6 is a view showing a screen picture displayed for the mask buyer when “Exposure simulation” is selected in the screen picture shown in FIG. 5;

FIG. 7 is a view showing a screen picture displayed for the mask buyer to select how to proceed with the mask trade; and

FIG. 8 is a view showing a screen picture displayed for the mask buyer after a reset price of the mask product is calculated.

### DETAILED DESCRIPTION OF THE INVENTION

Embodiments of the present invention will now be described with reference to the accompanying drawings. In the following description, the constituent elements having substantially the same function and arrangement are denoted by the same reference numerals, and a repetitive description will be made only when necessary.

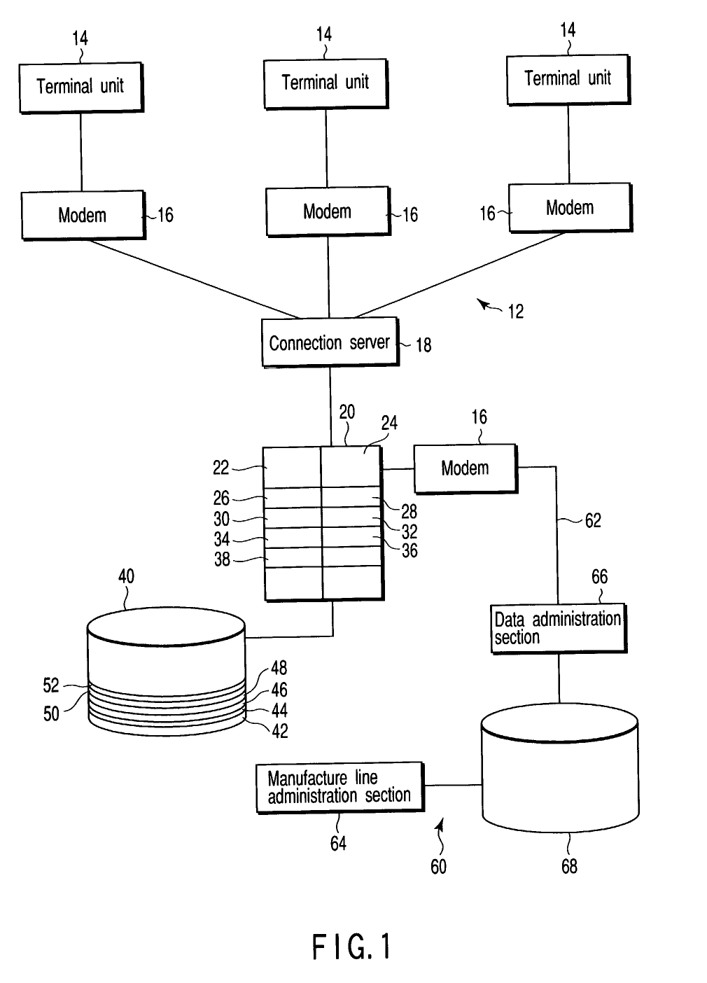

FIG. 1 is a block diagram showing how terminal units on a mask buyer side and a mask factory are related to a system for trading a photo mask used for manufacturing semiconductor devices, according to an embodiment of the present invention.

In this embodiment, a host apparatus (mask house) 20 of the mask trading system is disposed at a site accessible by a user's terminal unit 14, such as a personal computer, through a network 12, particularly through the transmission lines of Internet (public communication network). Accordingly, the host apparatus 20, i.e., a host computer (including a web server, application server, and database server), has a purchase agent (a purchase mediating section) 22, which is connected to the network 12 and is used as a window to exchange information with a mask buyer (a client or user, or a salesman on behalf of the client). The host apparatus 20 also has a sales agent (a sales mediating section) 24, which is connected through an exclusive line 62 to the mask factory 60 (a mask manufacturer and seller) and is used as a window to exchange information with the mask factory 60. Reference symbols 16 and 18 in FIG. 1 denote a modem and a connection server, respectively.

The host apparatus 20 is provided with a database 40, in which a manufacture order file 42, a delivery date information file 44, a price information file 46, an examination data file 48, an image data file 50, a simulation information file 52, and so forth are formed. The manufacture order file 42 is used to store a mask manufacture order, which includes the design specifications (including examination specifications in this embodiment), quantity, desired delivery date, and so forth of an ordered mask, and is inputted through the purchase agent 22. Where product names or product numbers of masks are set in advance between a mask buyer and the mask seller, the product names or product numbers of masks can be used as information representing design specifications of masks. The delivery date information file 44 is used to store delivery date information, which includes the relationship between mask manufacturing method and mask delivery date. The price information file 46 is used to store price information, which includes the relationship between mask manufacturing method and mask price, and the relationship between level of problem caused in a mask product and reset mask price.

The examination data file 48 is used to store the examination data of a mask product manufactured in the mask factory 60, which is inputted through the sales agent 24. The examination data includes data concerning line width uniformity provided in a mask product, defects generated in the mask product, and so forth, and it further includes data concerning transmittance, phase angle difference, and so forth in the case of a phase shift mask. The image data file 50 is used to store data of a shape image, which is obtained by, e.g., scanning electron microscope (SEM) photography, and includes the two-dimensional shapes of pattern corner portions, such as corner portions of an opening, in a mask product, which has been manufactured in the mask factory 60 in accordance with the design specifications of a mask. The examination data and the shape image are formed in the mask factory 60 or a separate examination department, and are inputted through the sales agent 24. The contents of the examination data can be changed, depending on, e.g., examination specifications set out in a mask manufacture order inputted by a mask buyer. The simulation information file 52 is used to store simulation information including the relationship between designed exposure conditions of exposure apparatuses, in which a mask is used, such as the wavelength of exposure light and NA (Numerical Aperture), and printed images to be obtained by performing exposure using respective patterns in accordance with each set of design specifications.

In order to perform a first stage mediation between a mask buyer and the mask seller, utilizing the above-described information stored in the database 40, the host apparatus 20 has an order receiving section 26, a calculating section 28, a manufacture instructing section 32, and so forth. The order receiving section 26 receives a mask manufacture order inputted by a mask buyer through the purchase agent 22, as described above. The calculating section 28 calculates an estimated price and an estimated delivery date of a mask product with reference to the price information and the delivery date information described above, in response to the mask manufacture order. The order receiving section 26 transmits the estimated price and the estimated delivery date to the mask buyer through the purchase agent 22, and allows the buyer to select whether to proceed with manufacture of the mask or not. The manufacture instructing section 32 transmits the mask manufacture order to the mask factory 60 through the sales agent 24, when proceeding with manufacture of the mask is selected in the order receiving section 26.

Furthermore, in order to perform a second stage mediation between the mask buyer and the mask factory 60, utilizing the above-described information stored in the database 40, the host apparatus 20 has an examination data providing section 34, an image providing section 36, a simulation section 38, a progress selection section 30, and so forth. The examination data providing section 34 and the image providing section 36 respectively transmit the examination data and the shape image described above to the mask buyer through the purchase agent 22. The simulation section 38 simulates a printed image on a wafer to be obtained by performing exposure with the shape image of a manufactured mask product, in response to a request from the mask buyer. In order to achieve this, the simulation section 38 allows the mask buyer, through purchase agent 22, to input designed exposure conditions of an exposure apparatus to be used, such as an exposure apparatus name, the wavelength of exposure light, and NA (Numerical Aperture), and uses them to simulate a printed image with reference to the simulation information described above. The image providing section 36 transmits the simulated image to the mask buyer through the purchase agent 22.

After the simulation section 38 and so forth provide the shape image, and the simulated image (if requested), to the mask buyer, the progress selection section 30 allows the mask buyer, through the purchase agent 22, to select whether to purchase the mask product, to reset the price of the mask product, or to re-manufacture a mask product in accordance with the design specifications of the mask. The progress selection section 30 further includes means for the mask buyer to input a reason for resetting the price of the mask product, such that a requirement concerning pattern corner portions or defects and set out in the design specifications of the mask is not satisfied. Resetting the price of the mask product is effective, for example, where the mask product includes a defect, thus does not conform to the design specifications of the mask, but is acceptable. When re-manufacture of the mask is selected in the progress selection section 30, the manufacture instructing section 32 instructs re-manufacture of the mask to the mask factory 60 through sales agent 24.

In the mask factory 60, the mask manufacture lines are administered by a manufacture line administration section 64 formed of, e.g., a computer. The mask factory 60 is connected to the host apparatus 20 of the mask trading system only by a data administration section 66 formed of, e.g., a computer. The manufacture line administration section 64 and the data administration section 66 are connected to a common factory database 68. The factory database 68 is used to store information transferred to and from the host apparatus 20 of the mask trading system, i.e., mask manufacture orders from mask buyers, line information of the manufacture lines, examination data of mask products, the shape images of pattern corner portions, and so forth.

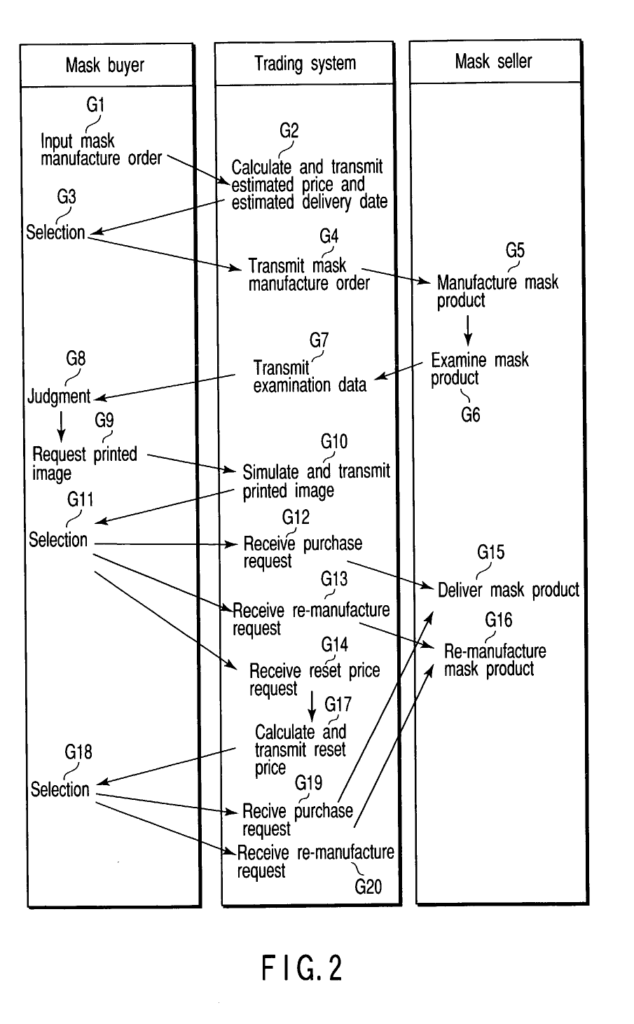

FIG. 2 is a flowchart showing a business flow of a mask trading method performed by the system shown in FIG. 1. An explanation will be given of a mask trading method according to an embodiment of the present invention, with reference to FIG. 2.

First, a mask buyer connects a user terminal unit 14 to the host apparatus 20 of the mask trading system through the network 12. It may be adopted to require an ID and a password, when a user terminal unit 14 is connected to the host apparatus 20. In this case, only users with a specific contract are allowed to access the host apparatus 20. Then, the mask buyer inputs a mask manufacture order including the design specifications (including examination specifications in this embodiment), quantity, desired delivery date, and so forth of the ordered mask, through the purchase agent 22 into the order receiving section 26 (step G1).

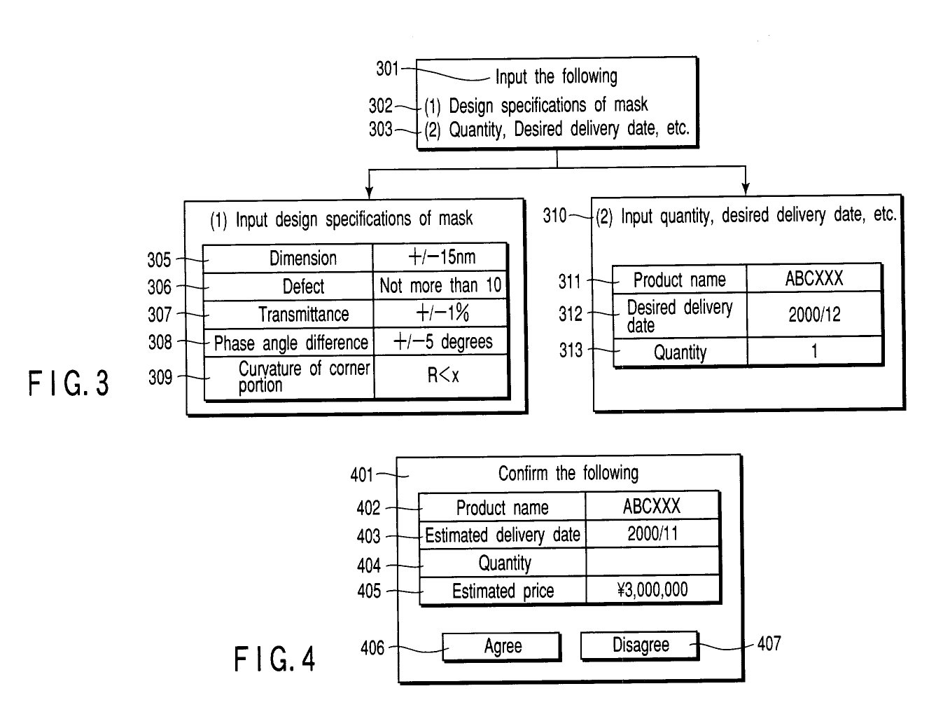

FIG. 3 is a view showing a screen picture displayed for the mask buyer to input the mask manufacture order. In this case, since the photo mask to be traded is a phase shift mask, the design specifications of the mask include “Transmittance” and “Phase angle difference”, as well as “Dimensions” (line width uniformity provided in a mask product) and “Defects” (defects generated in the mask product).

“Product Name” can be used where product names or product numbers of masks are set in advance between the mask buyer and the mask factory 60. In other words, a product name or product number of a mask is used as information representing design specifications of the mask, as the case may be.

When the mask manufacture order is inputted, the order receiving section 26 decides whether the ordered mask can be manufactured or not. Where the mask cannot be manufactured, the mask buyer is informed of this fact, and the trading does not take place. No explanation will be given of this case, because this departs from the features of the embodiment. Where the mask can be manufactured, the order receiving section 26 transfers the mask manufacture order to the calculating section 28. The calculating section 28 calculates an estimated price and an estimated delivery date of a mask product, with reference to the price information and the delivery date information stored in the price information file 46 and the delivery date information file 44 (step G2). The order receiving section 26 transmits (displays) the calculated estimated price and estimated delivery date to the mask buyer through the purchase agent 22 (step G2), and allows the buyer to select whether to proceed with manufacture of the mask or not (step G3).

FIG. 4 is a view showing a screen picture displayed for the mask buyer to select whether to proceed with manufacture of the mask or not. When “Disagree” is selected (i.e., to cancel the manufacture) in the screen picture shown in FIG. 4, the trading does not take place. On the other hand, when “Agree” is selected (i.e., to proceed with the manufacture) in the screen picture shown in FIG. 4, the host apparatus 20 stores the confirmed mask manufacture order, along with the estimated price and the estimated delivery date, into the manufacture order file 42. Furthermore, the manufacture instructing section 32 transmits the mask manufacture order to the data administration section 66 of the mask factory 60 through the sales agent 24 (step G4).

Upon receiving the mask manufacture order, the data administration section 66 provides the manufacture line administration section 64 with a manufacture instruction. On the basis of this, the manufacture line administration section 64 conducts manufacture of a mask product in the manufacture lines (step G5). After the mask product is completed, an examination of the product is performed in the mask factory 60 to form examination data and a shape image (step G6). The examination data are formed in accordance with the design specifications of the mask, and include data, e.g., concerning line width uniformity, defects, transmittance, phase angle difference, and so forth. The shape image is formed of data by scanning electron microscope (SEM) photography, and includes, e.g., the two-dimensional shapes of pattern corner portions in a mask product.

The data administration section 66 of the mask factory 60 inputs the examination data and the shape image into the host apparatus 20 through the sales agent 24, while clarifying the relationship of the examination data and the shape image relative to the corresponding mask manufacture order. The host apparatus 20 stores the inputted examination data and the shape image in the examination data file 48 and the image data file 50 of the database 40. The examination data providing section 34 and the image providing section 36 transmit (display) this data to the mask buyer through the purchase agent 22 (step G7). With reference to the examination data and the shape image, the mask buyer judges whether the mask product is usable or not (step G8).

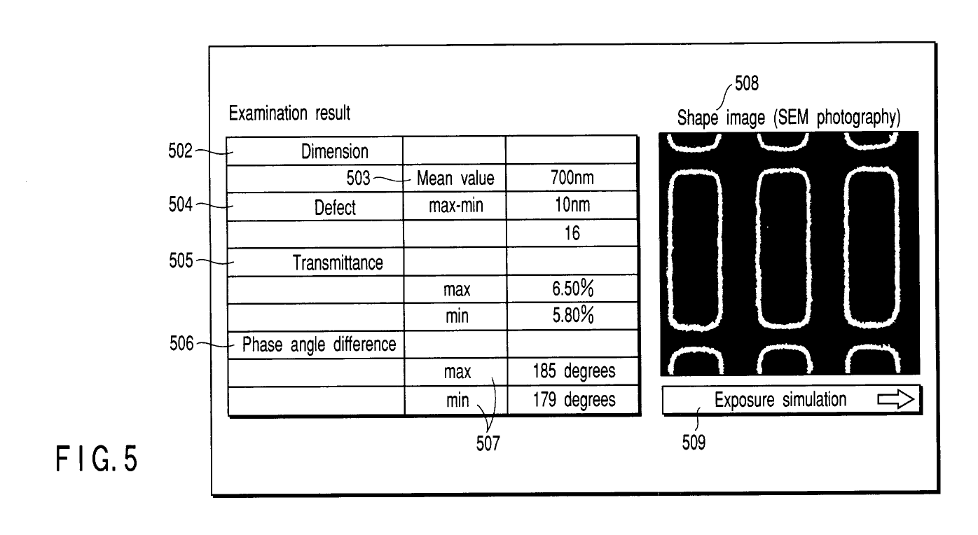

FIG. 5 is a view showing a screen picture displayed for the mask buyer to see the examination data and the shape image. In FIG. 5, “mean value” denotes the line width in the mask product, and “maxmin” denotes the difference between the maximum value and the minimum value of the line width. Also, in FIG. 5, several rectangular openings are shown in the shape image, wherein four corners of each opening are considered to be pattern corner portions. However, pattern corner portions are not limited to the corners of openings, but may be bent portions of wirings, or corners of a solid portion surrounded by an opening.

When the mask buyer cannot judge whether the mask product is usable or not, from the shape image of SEM photography shown in FIG. 5, the screen picture shown in FIG. 5 allows the mask buyer to select “Exposure simulation” so as to further request a printed image on a wafer to be obtained by performing exposure using the shape image (step G9). Upon receiving this request, the simulation section 38 inquires of the mask buyer through the purchase agent 22 as to designed exposure conditions of an exposure apparatus to be used. When designed exposure conditions of an exposure apparatus to be used are inputted, the simulation section 38 simulates a printed image with reference to the simulation information in the simulation information file 52 (step G10). The image providing section 36 transmits (display) a simulated printed image to the mask buyer through the purchase agent 22 (step G10).

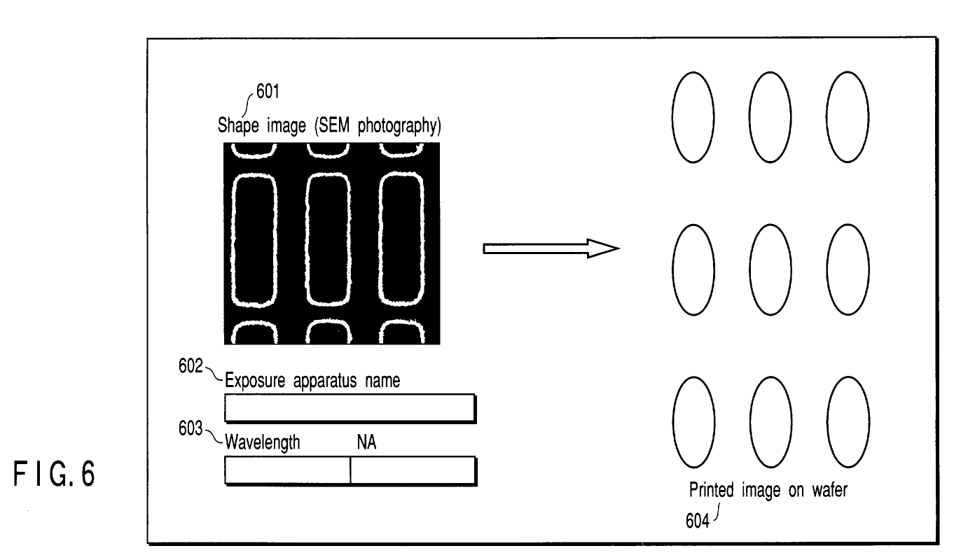

FIG. 6 is a view showing a screen picture displayed for the mask buyer when “Exposure simulation” is selected in the screen picture shown in FIG. 5. When information is inputted in blank columns for designed exposure conditions of an exposure apparatus (in this case, “Exposure apparatus name”, or “Wavelength of exposure light” and “NA” (Numerical Aperture)), which are positioned below the shape image displayed on the left side in the screen picture shown in FIG. 6, the simulated image is displayed on the right side in the screen picture shown in FIG. 6. As shown in FIG. 6, it is understood at a glance that the corners of openings become very round in the simulated image. Such information allows the mask buyer to reliably and readily judge whether the mask product is usable or not.

On the basis of the examination data and the shape image shown in FIG. 5, and further with reference to the simulated image shown in FIG. 6 if necessary, the mask buyer selects how to proceed with this mask trading (step G11). More specifically, the progress selection section 30 inquires of the mask buyer through purchase agent 22 and allows the mask buyer to select whether to buy the mask product, to reset the price of the mask product, and/or to re-manufacture a mask product in accordance with the design specifications of the mask. At this time, the mask buyer can input the reason why the price of the mask product should be reset, such that some conditions of pattern corner portions or defects do not conform to the design specifications of the mask. As described above, resetting the price of the mask product is effective, for example, where the mask product includes a defect, thus does not conform to the design specifications of the mask, but is acceptable. Accordingly, this prevents a waste of mask products.

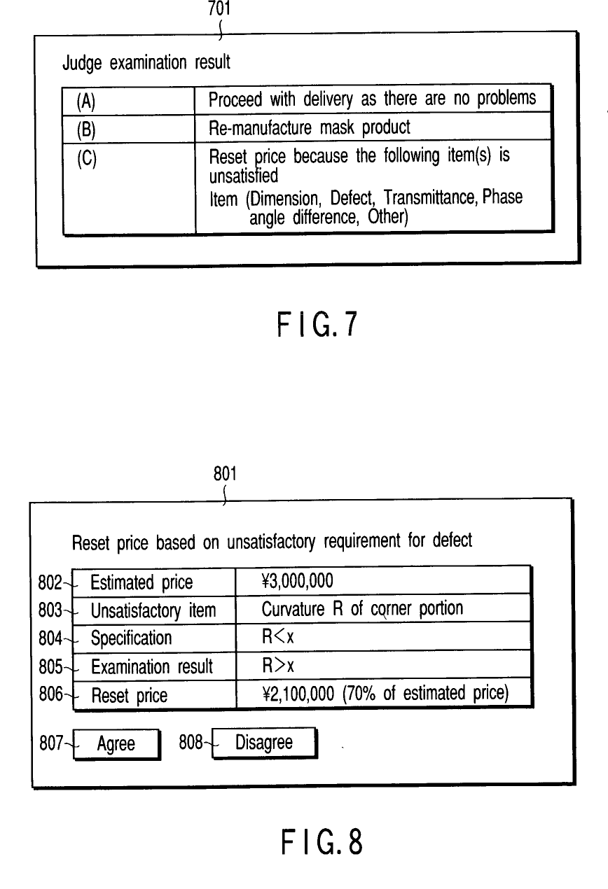

FIG. 7 is a view showing a screen picture displayed for the mask buyer to select how to proceed with the mask trade. When “(A)” is selected in the screen picture shown in FIG. 7 (step G12), the progress selection section 30 receives this as a mask purchase request, and transmits it to the mask factory 60. In this case, thereafter, the mask product is delivered from the mask factory 60 (step G15), and then is received by the mask buyer, who sequentially pays for the mask.

When “(B)” is selected in the screen picture shown in FIG. 7 (step G13), the progress selection section 30 transfers it to the manufacture instructing section 32. The manufacture instructing section 32 transmits a mask re-manufacture order to the data administration section 66 of the mask factory 60 through the sales agent 24. Upon receiving the mask re-manufacture order, the data administration section 66 provides the manufacture line administration section 64 with a re-manufacture instruction. On the basis of this, the manufacture line administration section 64 conducts re-manufacture of a mask product in the manufacture lines (step G16). Then, the steps from the examination step (step G6) are repeated.

When “(C)” is selected in the screen picture shown in FIG. 7 (step G14), the progress selection section 30 transfers it to the calculating section 28. The calculating section 28 calculates a reset price of the mask product with reference to the price information in the price information file 46 (step G17). The progress selection section 30 transmits (displays) the calculated reset price to the mask buyer through the purchase agent 22 (step G17), and allows the mask buyer to select whether to agree with it or not (step G18). The screen picture shown in FIG. 7 includes a column of “Item” belonging to “(C)”, which shows matters arbitrarily selectable by the mask buyer in accordance with reasons for not conforming to the requirements. Alternatively, the corresponding matters may be automatically displayed in reverse video by the host apparatus 20 in light of the design specifications of the mask included in the mask manufacture order.

FIG. 8 is a view showing a screen picture displayed for the mask buyer after a reset price of the mask product is calculated. When “Agree” is selected in the screen picture shown in FIG. 8 (step G19), the progress selection section 30 receives this as a mask purchase request, and transmits it to the mask factory 60. In this case, thereafter, the mask product is delivered from the mask factory 60 (step G15), and then is received by the mask buyer, who sequentially pays for the mask. On the other hand, when “Disagree” is selected in the screen picture shown in FIG. 8 (step G20), the progress selection section 30 receives this as a mask re-manufacture request, and transfers it to the re-manufacture instructing section 32. The remanufacture instructing section 32 transmits a mask remanufacture order to the data administration section 66 of the mask factory 60 through the sales agent 24.

In the embodiment described above, after simulation of the printed image is requested, designed exposure conditions of an exposure apparatus to be used are inputted. Alternatively, designed exposure conditions of an exposure apparatus may be inputted along with a mask manufacture order when the mask manufacture order is inputted. The host apparatus 20 may not be provided with the printed image simulation section 30, so that printed image simulation is performed on the mask buyer side. In this case, the mask buyer is allowed to take a shape image by SEM photography shown in FIG. 5 into the corresponding terminal unit 14 through the purchase agent 22.

Furthermore, in the embodiment described above, only one mask factory 60 is connected to the host apparatus 20 of the mask trading system, but a plurality of mask factories may be connected to the host apparatus 20 in parallel or in series. Where only one mask factory 60 is connected to the host apparatus 20 of the mask trading system, the data administration section 66 of the mask factory 60 and the host apparatus 20 of the mask trading system may be unified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask trading system for trading a photo mask used for manufacturing semiconductor devices, the system comprising:
a purchase mediating section configured to exchange information with a mask buyer through a network;
a sales mediating section configured to exchange information with a mask seller;
a manufacture order storing section configured to store a mask manufacture order, which includes design specifications of a mask, and is inputted through the purchase mediating section;
an image storing section configured to store a shape image, which includes a two-dimensional shape of a pattern corner portion in a mask product manufactured in a mask factory in accordance with the design specifications of the mask, and is inputted through the sales mediating section;
an image providing section configured to transmit the shape image to the mask buyer through the purchase mediating section.

2. A system according to claim 1, further comprising a simulation section configured to simulate a printed image to be obtained by performing exposure with a pattern corner portion having the shape image, with reference to designed exposure conditions of an exposure apparatus, wherein the image providing section is configured to transmit the printed image to the mask buyer through the purchase mediating section.

3. A system according to claim 2, wherein the simulation section is configured to allow the mask buyer to input the designed exposure conditions of an exposure apparatus through the purchase mediating section.

4. A system according to claim 1, further comprising an examination data storing section configured to store examination data of a defect in the mask product, which is inputted through the sales mediating section, and an examination data providing section configured to transmit the examination data to the mask buyer through the purchase mediating section.

5. A system according to claim 1, further comprising a progress selection section configured to allow the mask buyer through the purchase mediating section to select whether to purchase the mask product, or to re-manufacture a mask product in accordance with the design specifications of the mask, after the shape image is transmitted to the mask buyer.

6. A system according to claim 5, wherein the progress selection section is configured to allow the mask buyer to further select whether to reset a price of the mask product.

7. A system according to claim 6, wherein the progress selection section comprises a portion configured to allow the mask buyer to input a reason why the price of the mask product should be reset.

8. A system according to claim 6, further comprising a price information storing section configured to store price information including relationship between level of problem caused in a mask product and reset mask price, and a calculating section configured to calculate a reset price of the mask product with reference to the price information, in response to a request to reset the price.

9. A system according to claim 1, further comprising a price information storing section configured to store price information including relationship between mask manufacturing method and mask price, and a calculating section configured to calculate an estimated price of the mask product with reference to the price information, in response to the mask manufacture order.

10. A system according to claim 1, further comprising a delivery date information storing section configured to store delivery date information including relationship between mask manufacturing method and mask delivery date, and a calculating section configured to calculate an estimated delivery date of the mask product with reference to the delivery date information, in response to the mask manufacture order.

11. A mask trading method of trading a photo mask used for manufacturing semiconductor devices, using a system including a purchase mediating section configured to exchange information with a mask buyer through a network, and a sales mediating section configured to exchange information with a mask seller, the method comprising:
storing a mask manufacture order, which includes design specifications of a mask, and is inputted through the purchase mediating section;
storing a shape image, which includes a two-dimensional shape of a pattern corner portion in a mask product manufactured in a mask factory in accordance with the design specifications of the mask, and is inputted through the sales mediating section; and
transmitting the shape image to the mask buyer through the purchase mediating section.

12. A method according to claim 11, further comprising: simulating a printed image to be obtained by performing exposure with a pattern corner portion having the shape image, with reference to designed exposure conditions of an exposure apparatus; and transmitting the printed image to the mask buyer through the purchase mediating section.

13. A method according to claim 12, further comprising: allowing the mask buyer to input the designed exposure conditions of an exposure apparatus through the purchase mediating section.

14. A method according to claim 11, further comprising: storing examination data of a defect in the mask product, which is inputted through the sales mediating section; and transmitting the examination data to the mask buyer through the purchase mediating section.

15. A method according to claim 11, further comprising: allowing the mask buyer through the purchase mediating section to select whether to purchase the mask product, or to re-manufacture a mask product in accordance with the design specifications of the mask, after the shape image is transmitted to the mask buyer.

16. A method according to claim 15, further comprising: allowing the mask buyer to select whether to reset a price of the mask product, when selecting whether to purchase the mask product, or to remanufacture a mask product.

17. A method according to claim 16, further comprising: allowing the mask buyer to input a reason why the price of the mask product should be reset, when selecting whether to reset a price of the mask product.

18. A mask trading method of trading a photo mask used for manufacturing semiconductor devices, using a system including a purchase mediating section configured to exchange information with a mask buyer through a network, and a sales mediating section configured to exchange information with a mask seller, the method comprising:
storing in the system a mask manufacture order, which includes design specifications of a mask, and is inputted through the purchase mediating section;
transmitting the mask manufacture order from the system to a mask factory through the sales mediating section;
manufacturing a mask product in the mask factory in accordance with the design specifications of the mask;
forming a shape image, which includes a two-dimensional shape of a pattern corner portion in the mask product;
inputting the shape image into the system through the sales mediating section and storing the shape image in the system;
transmitting the shape image from the system to the mask buyer through the purchase mediating section; and
allowing the mask buyer through the purchase mediating section to select whether to purchase the mask product, or to re-manufacture a mask product in accordance with the design specifications of the mask, after the shape image is transmitted to the mask buyer.

19. A method according to claim 18, further comprising: allowing the mask buyer to select whether to reset a price of the mask product, when selecting whether to purchase the mask product, or to remanufacture a mask product.

20. A method according to claim 18, further comprising: simulating a printed image to be obtained by performing exposure with a pattern corner portion having the shape image, with reference to designed exposure conditions of an exposure apparatus; and transmitting the printed image to the mask buyer through the purchase mediating section.
